(19) United States
(12) Patent Application Publication
(10) Pub. No.: US 2008/0265031 A1
(43) Pub. Date: Oct. 30, 2008

(54) Electronic tag testing device and method

(75) Inventor: Ying-Chang Liu, Panchiao (TW)

Correspondence Address: TROXELL LAW OFFICE PLLC, SUITE 1404, 5205 LEESBURG PIKE, FALLS CHURCH, VA, 22041, US

(73) Assignee: CHENG LOONG CORPORATION

(21) Appl. No.: 11/790,471

(22) Filed: Apr. 25, 2007

(51) Int. Cl. G06K 5/00; G06K 7/015

(52) U.S. Cl. 235/437

(57) ABSTRACT

An electronic tag testing device and method includes a feeding mechanism, a retaining mechanism and an R/W system. The feeding mechanism has a belt conveyer, the retaining mechanism has moving-guiding boards, guiding board-fixing bases and guiding board-adjusters, wherein one end of the moving-guiding board is connected to the guiding board-adjuster for adjusting the position of the moving-guiding board, one end of the guiding board-adjuster is connected to the guiding board-fixing base, the guiding board-fixing base is fixed under the belt conveyer for fixing the moving-guiding board, and the moving-guiding board is mounted on the belt conveyer of the feeding mechanism, and the R/W system includes a reader and an electronic tag, wherein the electronic tag is attached to an object to be measured, the reader is mounted on the conveyer mechanism for reading the data radiated from the electronic tag, thereby a signal strength from the electronic tag as located at each portion on the outer surface of the object to be tested is detected to find a best attaching position for the electronic tag.

### FIELD OF THE INVENTION

The present invention is related to an electronic tag testing device and method, and more particularly to an electronic tag testing device and method which utilizes a retaining mechanism and an R/W system for executing performance tests in static and dynamic states, such that the present invention can find the best position for the electronic tag and can be applied to all kinds of objects, packages or the likes with electronic tag.

### BACKGROUND OF THE INVENTION

Owing to the improvement and development, the control of product quantity and quality has already evolved from manual counting into semi-manual control through using bar codes, which can be read into the computer for finding the product data thereafter.

Nowadays, a RFID electronic tag is developed to replace the bar codes. The RFID electronic tag is characteristic of high capacity and high sensitivity. In the electronic tag, data, such as product information and ID, can be inputted, and as being read by a reader, the electronic tag content and ID can be easily recognized. This fashion reduces the inconvenience raised in manual or bar code condition and also solves the problem of information reservation.

However, the RFID electronic tag still has some inconvenience. For example, the attaching position of the electronic tag to the object and the placing position of the object are both factors influencing the reading of the electronic tag. Currently, before attaching the electronic tag, a testing procedure for finding the best position might be executed, but since the electronic tag reading condition of the object in the dynamic state must be tested as the object is moving, a manually operated method is still employed, in which the object is taken by hand to pass through the region in front of the reader backward and forward for testing the dynamic state reading rate or maximum dynamic state reading distance. However, the control of dynamic speed or dynamic state testing distance by labor manually causes low reproducibility.

Consequently, owing to the technical defects described above, the applicant keeps on carving unflaggingly through wholehearted experience and research to develop a testing device, which has simplified testing process, low cost and convenient measuring mode for facilitating to find the best electronic tag attaching position.

### SUMMARY OF THE INVENTION

The object of the present invention is to provide an electronic tag testing device and method for solving the testing problem that the dynamic speed or dynamic testing distance has to be controlled manually.

Another object of the present invention is to provide an electronic tag testing device and method, thereby significantly improving the reproducibility of testing result of RFID high frequency performance and also enhancing convenience and practicality.

Another further object of the present invention is to provide an electronic tag testing device and method, which utilizes a high frequency RFID reader and an antenna thereof to detect objects, packages, or the like with high frequency RFID electronic tag attached thereon for achieving a dynamic reading rate test so as to find a best electronic tag attaching position.

For achieving the objects described above, the present invention is related to an electronic tag testing device and method including a feeding mechanism, a retaining mechanism and an R/W system. The feeding mechanism has a belt conveyer, the retaining mechanism has moving-guiding boards, guiding board-fixing bases and guiding board-adjusters, wherein one end of the moving-guiding board is connected to the guiding board-adjuster for adjusting the position of the moving-guiding board, one end of the guiding board-adjuster is connected to the guiding board-fixing base, the guiding board-fixing base is fixed under the belt conveyer for fixing the moving-guiding board, and the moving-guiding board is mounted on the belt conveyer of the feeding mechanism, and the R/W system includes a reader and an electronic tag, wherein the electronic tag is attached to an object to be measured, the reader is mounted on the conveyer mechanism for reading the data radiated from the electronic tag, thereby a signal strength from the electronic tag as located at each portion on the outer surface of the object to be tested is detected to find a best attaching position for the electronic tag.

### BRIEF DESCRIPTION OF THE DRAWINGS

The foregoing aspects and many of the attendant advance electronic tags of this invention will be more readily appreciated as the same becomes better understood by reference to the following detailed description, when taken in conjunction with the accompanying drawings, wherein:

FIG. 1 is a structural schematic view showing a testing device according to the present invention;

FIG. 2 is a structural schematic view showing a testing device in an embodiment according to the present invention; and

FIG. 3 is a flow chart showing the testing steps according to the present invention.

### DESCRIPTION OF THE PREFERRED EMBODIMENT

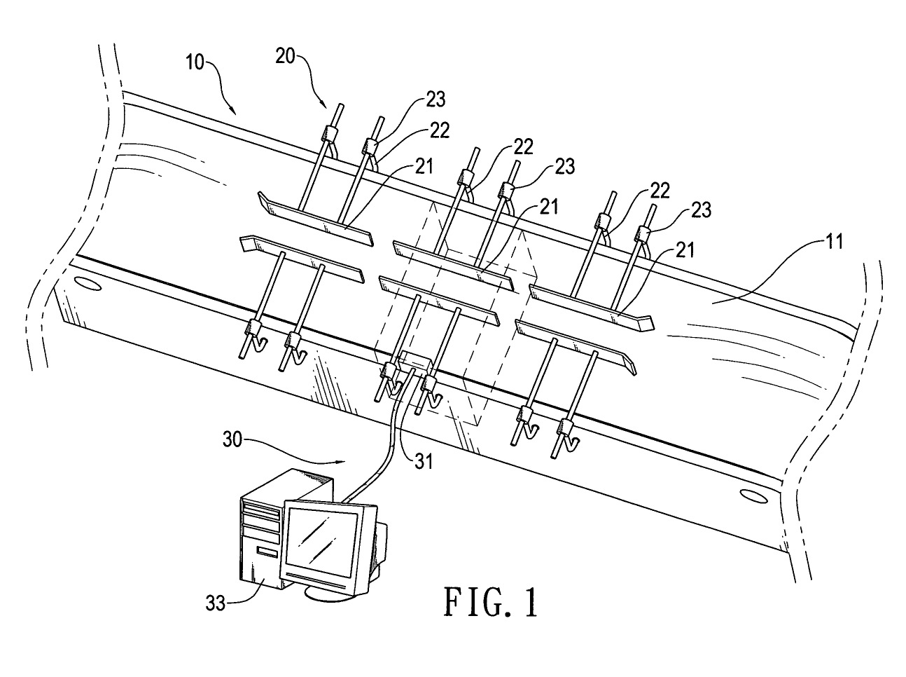

Please refer to FIG. 1, which is a structural schematic view showing an electronic tag testing device according to the present invention. The device includes a feeding mechanism 10, a retaining mechanism 20 and an R/W (Read/Write) system 30. The feeding mechanism 10 has a belt conveyer 11, whose speed can be adjusted, and the retaining mechanism 20 has moving-guiding boards 21, guiding board-fixing bases 22 and guiding board-adjusters 23, wherein one end of the guiding board-adjuster 23 is connected to the moving-guiding board 21 for adjusting the position of the moving-guiding board 21, and the other end of the guiding board-adjuster 23 is connected to the guiding board-fixing base 22, and the guiding board-fixing base 22 is fixed under the belt conveyer 11 for fixing the moving-guiding board 21. Further, the R/W system 30 includes a reader 31 and an electronic tag 32, wherein the electronic tag 32 is attached to the object to be measured, the reader 31 is mounted on the conveyer mechanism 10, under the reader 31, there is a hollow space, and the reader 31 is mounted above the belt conveyer 11 in a horizontal or vertical direction for reading the data radiated from the electronic tag 32, wherein the reader 31 in the R/W system 30 is further connected to a computer system 33, and in the computer system 33, a testing firmware is installed for collecting the testing data.

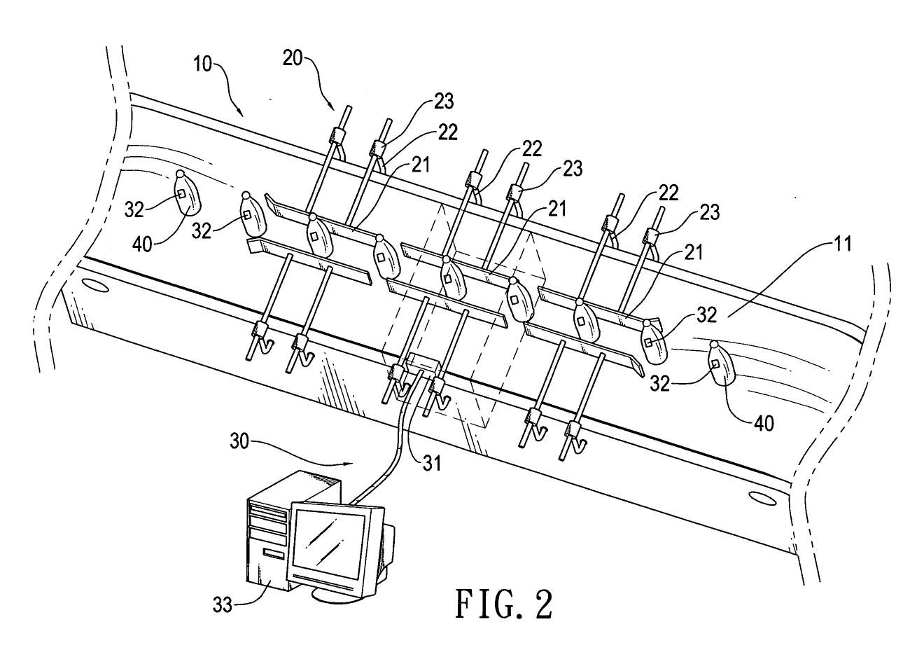

Please refer to FIG. 2, which is a structural schematic view showing an electronic tag testing device in an embodiment according to the present invention. The testing device can cooperate with all kinds of RFID (Radio Frequency Identification) high frequency readers 31 and electronic tags 32 in the market so as to measure data of important functions of objects attached by RFID high frequency electronic tags 32 as in a static or dynamic state. Thereby, the signal strength from the electronic tag 32 as located at each portion on the outer surface of the object to be tested can be evaluated for finding the best attaching position for the electronic tag 32 so as to benefit to draft a reference or a solution as practically applied. The application frequency can be ranged from 1 to 20 MHz so that it can match to particular frequency, or multiple frequencies, or conform to different packages and different content materials, such as metal, liquid, glass, plastic . . . etc. Just like this embodiment, a retaining mechanism 20 is mounted on the belt conveyer 11, and the retaining mechanism 20 includes the moving-guiding boards 21, the guiding board-fixing bases 22 and the guiding board-adjusters 23, wherein the moving-guiding board 21 is positioned on the belt conveyer 11 of the feeding mechanism 10, one side of the moving-guiding board 21 is connected to the guiding board-adjuster 23 for adjusting the position of the moving-guiding board 21, one side of the guiding board-adjuster 23 is connected to the guiding board-fixing base 22, and the guiding board-fixing base 22 is fixed under the belt conveyer 11 for fixing the moving-guiding board 21. This embodiment takes the electronic tag 32 attached on a bottle 40 as an example. The moving-guiding boards 21 form the moving path and adjust the feeding speed and testing distance of the belt conveyer 11, the electronic tag 21 is attached to the bottle 40, and the reader 31 of the R/W system reads the data radiated from the electronic tag 32 and transmits the data to the computer system 33 for collection, thereby facilitating to decide the best attaching position, wherein in the computer system 33, a firmware for testing the static/dynamic state of the bottle so as to actuate the testing procedure and also monitor the testing steps.

In the static/dynamic state testing firmware, there are three testing methods relating maximum static state reading distance, maximum dynamic state reading distance, and dynamic state reading rate. In the maximum static state reading distance test, the relative distance between the object to be tested on the speed changeable belt conveyer 11 and the high frequency reader 31 is measured and the static state testing firmware will confirm if the data radiated from the electronic tag is read. If yes, the distance is increased until the data can not be read, and then the last relative distance becomes the maximum static state reading distance. In the maximum dynamic state reading distance test, the distance between the moving-guiding boards 21 at opposite two sides are adjusted such that the object to be tested on the speed changeable belt conveyer 11 can retain a constant distance with the fixed high frequency reader 31 as moving on the belt conveyer 11, then the belt conveyer 11 is actuated (at a speed based on demands), and the static/dynamic state testing firmware confirms if the data from the electronic tag 32 can be read. If yes, the distance is further increased until the data cannot be read, and then the last relative distance becomes the maximum dynamic state reading distance. Moreover, in the dynamic reading rate test, the distance between the moving-guiding boards 21 at opposite two sides are adjusted such that the object to be tested on the speed changeable belt conveyer 11 can retain a constant distance with the fixed HF reader 31 as moving on the belt conveyer 11, then the belt conveyer 11 is actuated (at a speed based on demands), and the static/dynamic state testing firmware confirms if the data from the electronic tag 32 can be read. The sum of recognized RFID electronic tags 32 divided by the sum of objects passing through the fixed high frequency reader 31 equals the dynamic reading rate.

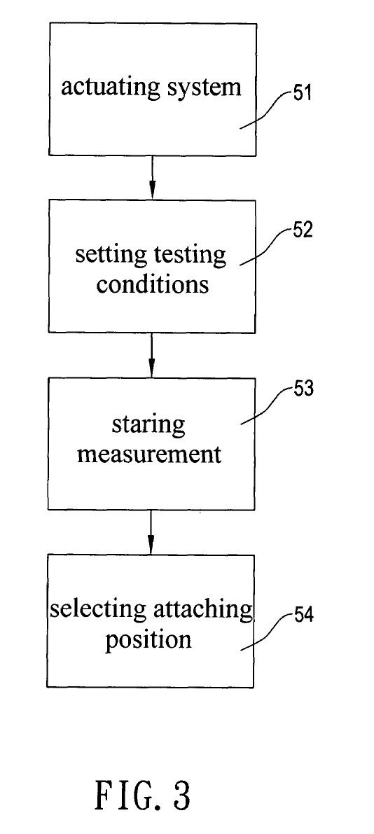

Please refer to FIG. 3, which is a flow chart showing the steps of electronic tag testing method according to the present invention. The method includes steps of: actuating system 52, in which the computer system is connected to the R/W system and the firmware in the computer system is initiated; setting testing conditions 52, in which one side of the moving-guiding board in the retaining mechanism is connected to the guiding board-adjuster, one end of the guiding board-adjuster is connected to the guiding board-fixing base, the guiding board-fixing base is fixed under the belt conveyer, the moving-guiding board is mounted on the belt conveyer, the electronic tag of the R/W system is attached to the object to be tested, the reader of the R/W system is mounted on the feeding mechanism, the distance to be measured in the retaining mechanism and the position of the object are positioned, and the speed of the feeding mechanism is set up; starting measurement 53: in which the firmware is executed, the feeding mechanism is actuated, the detection between the reader and the electronic tag is implemented, and the detection result is transmitted back to the computer system; and selecting an attaching position 54, in which the computer system decides the best position of the electronic tag.

In the aforesaid, the device according to the present invention has the advance electronic tags that:

1. The device owns a better convenience and practicality other than the significantly improved reproducibility of testing result of RFID high frequency performance.

2. The device has an application frequency ranged from 1 to 20 MHz so that it can match to particular frequency, or multiple frequencies, or conform to different packages and different content materials, such as metal, liquid, glass, plastic . . . etc.

3. The device can be used to find the best position for attaching the electronic tag.

It is to be understood, however, that even though numerous characteristics and advance electronic tags of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electronic tag testing device, comprising:
a feeding mechanism, having a belt conveyer;
a retaining mechanism, having moving-guiding boards, guiding board-fixing bases and guiding board-adjusters, wherein one end of the moving-guiding board is connected to the guiding board-adjuster for adjusting the position of the moving-guiding board, one end of the guiding board-adjuster is connected to the guiding board-fixing base, the guiding board-fixing base is fixed under the belt conveyer for fixing the moving-guiding board, and the moving-guiding board is mounted on the belt conveyer of the feeding mechanism; and
an R/W system, having a reader and an electronic tag, wherein the electronic tag is attached to an object to be measured, the reader is mounted on the conveyer mechanism for reading the data radiated from the electronic tag,
thereby a signal strength from the electronic tag as located at each portion on the outer surface of the object to be tested is detected to find a best attaching position for the electronic tag.

2. The device as claimed in claim 1, wherein the reader of the R/W system is a high frequency reader.

3. The device as claimed in claim 1, wherein the R/W system is further connected to a computer system, which has a static/dynamic state testing firmware installed therein for collecting testing data.

4. The device as claimed in claim 1, wherein the feeding mechanism under the reader is formed to have a hollow space.

5. The device as claimed in claim 1, wherein the reader of the R/W system is mounted above the belt conveyer in a horizontal direction.

6. The device as claimed in claim 2, wherein the reader of the R/W system is mounted above the belt conveyer in a horizontal direction.

7. The device as claimed in claim 1, wherein the reader of the R/W system is mounted above the belt conveyer in a vertical direction.

8. The device as claimed in claim 2, wherein the reader of the R/W system is mounted above the belt conveyer in a vertical direction.

9. A method for testing electronic tag, comprising steps of:
actuating system: in which the computer system is connected to the R/W system and the firmware in the computer system is initiated;
setting testing conditions: in which one side of the moving-guiding board in the retaining mechanism is connected to the guiding board-adjuster, one end of the guiding board-adjuster is connected to the guiding board-fixing base, the guiding board-fixing base is fixed under the belt conveyer, the moving-guiding board is mounted on the belt conveyer, the electronic tag of the R/W system is attached to the object to be tested, the reader of the R/W system is mounted on the feeding mechanism, the distance to be measured in the retaining mechanism and the position of the object are positioned, and the speed of the feeding mechanism is set up;
starting measurement: in which the firmware is executed, the feeding mechanism is actuated, the detection between the reader and the electronic tag is implemented, and the detection result is transmitted back to the computer system; and
selecting an attaching position: in which the computer system decides a best position of the electronic tag.

10. The device as claimed in claim 7, wherein the reader of the R/W system is a high frequency reader.

11. The device as claimed in claim 7, wherein the R/W system is further connected to a computer system, which has a static/dynamic state testing firmware installed therein for collecting testing data.

12. The device as claimed in claim 7, wherein the feeding mechanism under the reader is formed to have a hollow space.

13. The device as claimed in claim 7, wherein the reader of the R/W system is mounted above the belt conveyer in a horizontal direction.

14. The device as claimed in claim 8, wherein the reader of the R/W system is mounted above the belt conveyer in a horizontal direction.

15. The device as claimed in claim 7, wherein the reader of the R/W system is mounted above the belt conveyer in a vertical direction.

16. The device as claimed in claim 8, wherein the reader of the R/W system is mounted above the belt conveyer in a vertical direction.
